(19) United States
(12) Patent Application Publication
(10) Pub. No.: US 2005/0122957 A1
(43) Pub. Date: Jun. 9, 2005

(54) Router, traffic volume control method therefor, communication system, and traffic control program recorded computer-readable recording medium

(76) Inventor: Michiko Ambe, Kawasaki (JP)

Correspondence Address: Katten Muchin Zavis Rosenman;IP Department, 575 Madison Avenue, New York, NY, 10022-2585, US

(21) Appl. No.: 11/030,398

(22) Filed: Jan. 6, 2005

Related U.S. Application Data
(63) Continuation of application No. PCT/JP02/12233, filed on Nov. 22, 2002.

(51) Int. Cl. H04L 12/28

(52) U.S. Cl. 370/351

(57) ABSTRACT

A router suitable for use, for example, in a user site receiving an L2-VPN service, which constructs a network in which the communication efficiency does not degrade even in the case of the employment of a virtual private network which does not have a frame abandonment notification function or an abandonment function based on priority. The router, connected through a bridge unit to a transit network constituting a virtual private network, is made up of a reception traffic volume measuring unit for measuring a reception traffic volume on data received from all next hop routers forming other communication parties connected through the transit network and a measurement result notifying unit for notifying a measurement result on the measured reception traffic volume to all the next hop routers.

### BACKGROUND OF THE INVENTION

(1) Field of the Invention

The present invention relates to a router, traffic volume control method therefor, communication system and traffic control program recorded computer-readable recording medium suitable for use in a user's site receiving, for example, L2-VPN (Layer 2-Virtual Private Network) services.

(2) Description of the Related Art

A VPN signifies a network with a higher-security function, capable of making safe communications even by way of the Internet by making mutual connections, like dedicated lines, between sites through the use of encryption technique or capsulaizing technique.

FIG. 11 is an illustration of a network establishing one example of a conventional L2-VPN service a network carrier provides. The network shown in FIG. 11 includes a transit network 100 comprising bridge functions, and LANSWs (Local Area Network Switches) 121 to 124 constituting the transit network 100 are connected to routers 111 to 114 of user networks 101 to 104 forming sites, respectively.

As the routers 111 to 114 of the user networks 101 to 104 shown in FIG. 11, the L2-VPN enables connectionless access to a plurality of sites through the use of one interface. That is, an identifier indicative of a site to which a packet is addressed is not added to a packet. For example, the router 111 of the user network 101 shown in FIG. 11 is designed to gain connectionless access to the routers 112 to 114 of the three user networks 102 to 104.

In addition, accesses are made through access lines 131 to 134 between each of the routers 101 to 104 and each of the LANSWs 121 to 124 as shown in FIG. 11 and, in general, these access lines and the transit network 100 are different in contract from each other. That is, as the bands of the transit network 100 and the aforesaid access lines 131 to 134, selection is made from a best effort type and a band assurance type.

For example, a best effort type of 100 Mbps can be selected for the access lines 131 to 134 between the routers 111 to 114 and the LANSWs 121 to 124, while a band assurance type of 100 Mbps can be selected for the transit network 100.

The band assurance type assures a minimum band. That is, a traffic to be transmitted under assurance is handled as the best effort type. Incidentally, as the aforesaid transit network 100, there are two types: a type shared by a plurality of users and a type monopolized by one user.

At this time, for example, if overflow occurs at an exit (for example, the access lines 131 to 134) of the transit network 100, frames are abandoned in these access lines 131 to 134. Incidentally, since the L2-VPN is made up of bridge functions, it does not have a congestion notification function to the transmission/reception side routers 111 to 114.

In TCP/IP (Transmission Control Protocol/Internet Protocol) forming an upper layer relative to L2, there is defined a function which suppresses transmission quantity to an opposite end system (terminal accommodated in a router, or the like) by using an ICMP (Internet Control Message Protocol) message when a reception buffer reaches a full condition so that frame abandonment occurs or tends to occur.

However, in a case in which the traffic concentrates to the user networks 101 to 104 at one site to run above the access line rate or transit network rate at that site, there is a possibility of the occurrence of frame abandonment. In the user network 101 to 104 side units, such ad the router units 111 to 114, connected to the L2-VPN, in a case in which frame abandonment occurs in the access lines 131 to 134 or the transit network 100 as mentioned above, difficulty is experienced in detecting this occurrence thereof.

That is, as shown in FIG. 11, in a case in which the connections among the user networks 101 to 104 in a plurality of sites are made through the use of an L2-VPN service, if the concentration of the traffic occurs in one site, the frame abandonment arises in the access lines 131 to 134 or the transit network 100, which particularly degrades the communication quality of real-time-type applications (telephone, stream).

The occurrence of the frame abandonment in the access lines 131 to 134 or in the transit network 100 is unavoidable under the conventional ICMP congestion control. This is because the traffic suppression in the routers 111 to 114 is made to consistently promote the traffic suppression when a reception buffer falls into an overflow condition or its own processing bottlenecks.

In this connection, since most of routers are designed in consideration of a plurality of high-speed LAN supports, they usually have a function to prevent the occurrence of congestion therein even at the inflow of 100% traffic from the L2-VPN and, hence, there is a low possibility of carrying out the congestion control in the ICMP with respect to the L2-VPN.

Moreover, as a technique related to the invention as claimed in the application concerned, Japanese Patent Laid-Open No. 2000-349776 (which will be referred to hereinafter as patent document) discloses a technique about a route detouring method to be employed at in-switch congestion, which assures the traffic from end users by making a detour with IP protocol or hardware for distributing the load biased to an ATM (Asynchronous Transfer Mode) switch.

However, in a case in which the aforesaid patent document is applied to the L2-VPN network configuration shown in the aforesaid FIG. 11 where the connection to the transit network 100 is made through the access lines 111 to 114, difficulty is encountered in making a further detour on the access lines 131 to 134 serving as interfaces to the user networks 101 to 104, which can develop a possibility of the occurrence of frame abandonment as well as the above-mentioned case.

The present invention has been developed in consideration of these problems, and it is therefore an object of the invention to provide a router, traffic volume control method therefor, communication system, and traffic control program recorded computer, capable of constructing a network which can prevent the degradation of communication efficiency in employing a virtual private network having no frame abandonment notification function and no abandonment function based on priority.

### SUMMARY OF THE INVENTION

For achieving the above-mentioned purpose, a router according to the present invention, connected through a bridge unit to a transit network constituting a virtual private network, is characterized by comprising a reception traffic volume measuring unit for measuring a reception traffic volume on data received from all next hop routers forming other communication parties connected through the transit network, and a measurement result notifying unit for notifying a measurement result on the measured reception traffic volume to all the next hop routers.

Moreover, the router according to the present invention is characterized by comprising, in addition to the aforesaid configuration, a transmission traffic control unit for, when receiving the notification on the measurement result of the reception traffic volume in any one of the next hop routers from this next hop router, controlling a transmission traffic volume to this next hop router in accordance with the measurement result notified from this next hop router.

Furthermore, a router according to the present invention, connected through a bridge unit to a transit network constituting a virtual private network, is characterized by comprising an interface unit for carrying out transmission/reception of data with respect to all next hop routers forming other communication parties connected to the transit network and a relay control unit for carrying out relay control on data between the interface unit and a local interface unit made to conduct transmission/reception of data with respect to a local unit accommodated thereunder, wherein the interface unit includes a reception traffic volume measuring unit for measuring a reception traffic volume on data received from all the next hop routers through the transit network and a measurement result notifying unit for notifying a measurement result of the reception traffic volume, measured in the reception traffic volume measuring unit, to all the next hop routers, while the relay control unit includes a control data producing unit for producing control data corresponding to the measurement result to be notified by the measurement result notifying unit on the basis of the reception traffic volume measured in the reception traffic result measuring unit, with a request being made to all the next hop routers so as to control a traffic volume on transmitted data to themselves on the basis of the measurement result notified by the measurement result notifying unit.

Still furthermore, the router according to the present invention is characterized in that, in addition to the above-mentioned configuration, the interface unit includes a transmission traffic control unit for, when receiving a measurement result of the reception traffic volume in any one of the next hop routers from this next hop router, controlling a transmission traffic volume to this next hop router in accordance with the measurement result notified from this next hop router.

Yet furthermore, preferably, the interface unit includes a threshold decision unit for making a decision on magnitude relation between the reception traffic volume measured by the reception traffic volume measuring unit and a predetermined threshold, and when a result of the decision in the threshold decision unit shows that the reception traffic volume exceeds the predetermined threshold, the control data producing unit puts this fact into the control data.

More preferably, the measurement result notifying unit, when a result of the decision in the threshold decision unit shows that the reception traffic volume exceeds the predetermined threshold, makes a notification for a request to the next hop router for suppression of transmission data volume to the router, to which it pertains, so as to eliminate a possibility of occurrence of congestion in the virtual private network.

Moreover, preferably, the transmission traffic control unit controls the transmission traffic volume to the next hop router to a first suppressed traffic volume for a first period of time after the reception of the information from the next hop router and, for a second period of time after the elapse of the first period of time, carries out increase control to increase the transmission traffic volume gradually toward a second traffic volume intended.

Still moreover, it is also appropriate that, when carrying out the transmission traffic control, the transmission traffic control unit controls the transmission traffic volume while transmitting transmission data according to priority.

Yet moreover, preferably, it is also appropriate that the measurement result notifying unit notifies the measurement result according to ICMP (Internet Control Message Protocol).

It is also acceptable that the measurement result in the measurement result notifying unit is notified through a management server made to manage the virtual private network, or that it is notified according to a format based on an original protocol.

In addition, a traffic control method for a router connected through a bridge unit to a virtual private network according to the present invention is characterized by comprising a traffic volume measuring step of, when communication is made with respect to all next hop routers forming other communication parties connected through the virtual private network, measuring a reception traffic volume on data received from the next hop routers through the virtual private network, a notification step of notifying a measurement result on the measured reception traffic volume to all the next hop routers, and a transmission traffic control step of, in all the next hop routers, controlling a transmission traffic to the router in accordance with the notified measurement result.

Still additionally, a communication system according to the present invention, which is made to make communication between routers connected through a bridge unit to a virtual private network, is characterized in that a router, which receives data from all next hop routers forming other communication parties connected through the virtual private network, comprises a reception traffic volume measuring unit for measuring a reception traffic volume on data received from all the next hop routers and a measurement result notifying unit for notifying a measurement result on the measured reception traffic volume to all the next hop routers, and the next hop router, which receives the notification from the measurement result notifying unit, comprises a transmission traffic control unit for controlling a transmission traffic to the router in accordance with the notified measurement result.

Furthermore, a traffic control program recorded computer-readable recording medium according to the present invention, which is for recording a traffic control program, which makes a computer, serving as a router connected through a bridge unit to a virtual private network, carry out a traffic control function to control a traffic volume of the router, is characterized in that the traffic control program makes the computer fulfill functions as a reception traffic volume measuring unit for measuring a reception traffic volume on data received from all next hop routers, forming other communication parties connected through the virtual private network, through the virtual private network and a measurement result notifying unit for notifying a measurement result on the measured reception traffic volume to all the next hop routers.

Still furthermore, a traffic control program recorded computer-readable recording medium according to the present invention, which is for recording a traffic control program, which makes a computer, serving as a router connected through a bridge unit to a virtual private network, carry out a traffic control function to control a traffic volume of the router, is characterized in that the traffic control program makes the computer fulfill functions as a reception traffic volume measuring unit for measuring a reception traffic volume on data received from all next hop routers, forming other communication parties connected through the virtual private network, through the virtual private network, a measurement result notifying unit for notifying a measurement result on the measured reception traffic volume to all the next hop routers, and a transmission traffic control unit for, when receiving the notification on the measurement result of the reception traffic volume in any one of the next hop routers from the next hop router, controlling a transmission traffic to this next hop router in accordance with the measurement result notified from the next hop router.

As described above, according to the present invention, a router has functions as a reception traffic volume measuring unit, a measurement result notifying unit and a transmission traffic volume control unit and, hence, in a case in which, when the router connected to an edge of a user measures its own router reception volume, the measurement result shows that congestion tends to occur in an access line or in a transit network, the router notifies this fact to other routers so that the router, which has received the notification, controls a volume to be transmitted for preventing the occurrence of frame abandonment. This provides an advantage of constructing a network so as not to degrade the communication efficiency in the case of the employment of a layer-2 virtual private network which does not have a frame abandonment notification function and an abandonment function based on priority.

### BRIEF DESCRIPTION OF DRAWINGS

FIG. 1 is an illustration of an L2-VPN network using mode according to an embodiment of the present invention.

FIG. 2 is a flow chart for explaining a traffic control method for a router according to an embodiment of the present invention.

FIG. 3 is a block diagram showing a router according to an embodiment of the present invention.

FIGS. 4 and 7 are block diagrams showing an essential part of a router according to an embodiment of the present invention.

FIG. 5(a) is an illustration of a first table according to an embodiment of the present invention, and FIG. 5(b) is an illustration of a second table according to an embodiment of the present invention.

FIG. 6(a) to FIG. 6(d) are block diagram showing a format for an ICMP message to be used as a rate control packet to be transmitted/received between routers according to an embodiment of the present invention.

FIGS. 8 to 10 are flowcharts for explaining an operation for traffic control in a router connected to a transit network according to an embodiment of the present invention.

FIG. 11 is an illustration of a network forming one example of a conventional L2-VPN service provided by a network carrier.

### DESCRIPTION OF THE PREFERRED EMBODIMENTS

(a) Description of Embodiment of the Present Invention

An embodiment of the present invention will be described hereinbelow with reference to the drawings.

(a1) Description of Network Configuration According to Embodiment of the Present Invention

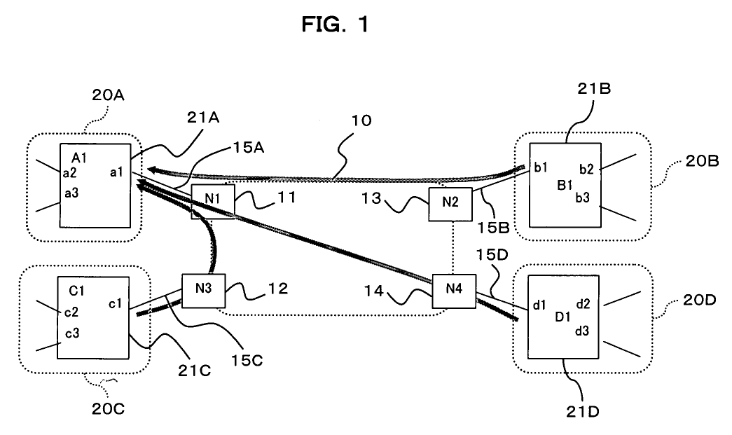

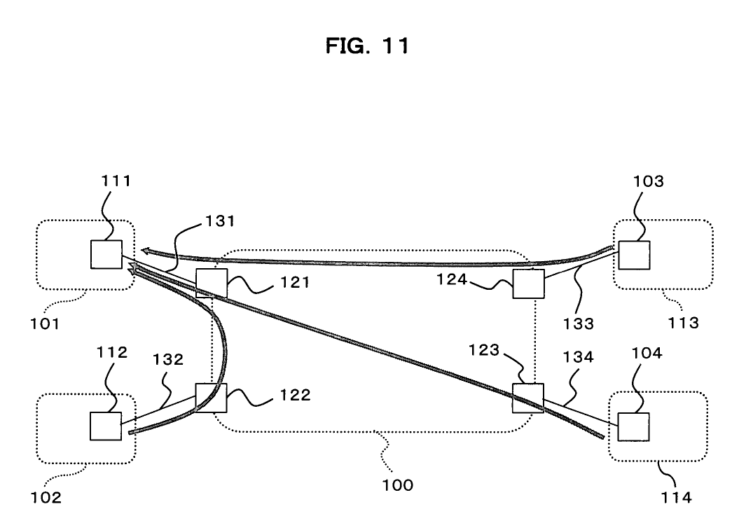

FIG. 1 is an illustration of an L2-VPN network using mode according to an embodiment of the present invention, and a communication system 1 shown in FIG. 1 is one example of an L2-VPN service as well as the above-described case shown in FIG. 11 and is made up of a transit network line 10 serving as a virtual facility network comprising a bridge function and user networks 20A to 20D connected to the transit network line 10.

That is, LANSWs 11 to 14 constituting the transit network line 10 are connected through access lines 15A to 15D to routers 21A to 21D of the user networks 20A to 20D serving as sites, respectively. The LANSWs 11 to 14 are for bridging a frame transmitted. That is, the LANSWs 11 to 14 make a reference to a physical address at a data link layer of the layer 2 to relay a frame.

Moreover, each of the routers 21A to 21D includes ports a1 to d1 for making connections to the aforesaid access lines 15A to 15D and ports a2 to d2 and a3 to d3 for making connections to local networks placed thereunder. This enables communications to be made through the access lines 15A to 15D and the transit network 10 even between terminals accommodated in the routers 21A to 21D different from each other.

That is, the routers 21A to 21D are connected through the L2-VPN made up of the transit network line 10 and the access lines 15A to 15D, and this L2-VPN enables mutual connectionless access to be made between the sites (routers 21A to 21D).

In this case, although both the transit network line 10 and access lines 15A to 15D organize the L2-VPN as mentioned above, they can be constructed as lines having characteristics different from each other. For example, it is possible that the access lines 15A to 15D are of a best effort type of 100 Mbps while the transit network line is of a band assurance type of 100 Mbps.

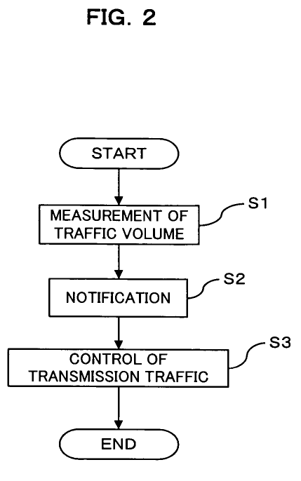

In this network configuration, as a communication system designed to make communications between the routers 21A to 21D connected through bridge units 11 to 14 to the transit network 10, connections are made as shown in FIG. 2, thereby controlling a traffic volume in each of the routers 21A to 21D.

Although the following description will be given focusing on a case in which the router 21A receives frame data from next hop routers (routers forming other communication parties with the router 21A) 21B to 21D, this also applies to a case in which the routers 21B to 21D other than the router 21A receive frame data from the next hop routers.

That is, as shown in FIG. 2, when making communication with all the next hop routers 21B to 21D forming opposite communication parties connected through the transit network 10 serving as a virtual private network, the router 21A measures a reception traffic volume on frame data received from the next hop routers 21B to 21D through the transit network 10, i.e., frame data inputted from the bridge unit 11 (step S1, traffic volume measuring step).

Subsequently, a measurement result on the reception traffic volume measured in the router 21A is notified to all the aforesaid next hop routers 21B to 21D (step S2, notification step).

Concretely, a decision is made as to magnitude relation between the reception traffic volume measured in the router 21A and a predetermined threshold. When the decision shows that the aforesaid reception traffic volume exceeds the predetermined threshold, information to the effect of it is inserted into a control packet and notified to all the next hop routers 21B to 21D. In other words, the router 21A performs the notification on the fact that the reception traffic volume exceeds the predetermined threshold and the probability of the occurrence of frame abandonment becomes relatively high in the transit network 10 acting as the layer 2 (L2) virtual facility network or in the access line 15A.

When receiving the control packet from the router 21A through the transit network 10, each of the aforesaid next hop routers 21B to 21D controls the transmission traffic on data to be transmitted to this router 21A (step S3, transmission traffic control step).

That is, each of the routers 21B to 21D suppresses the transmission traffic volume to the router 21A to a predetermined volume. This suppresses the traffic concentration in the access line 15A making connection between the bridge unit 11 and the router 21A, thereby preventing the occurrence of a congestion state or frame abandonment.

(a2) Description of Configuration of Router According to Embodiment of the Present Invention

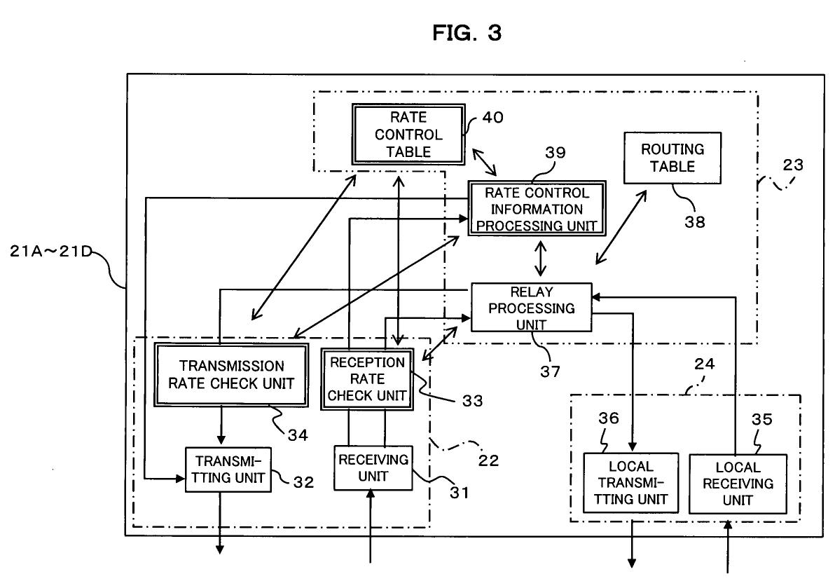

For example, shown in FIG. 3, the routers 21A to 21D connected to the transit network as shown in FIG. 1 are made up of an interface unit 22, a relay control unit 23 and a local interface unit 24, which enables the aforesaid traffic volume control shown in FIG. 2.

Although, for convenience only, the following description will be made focusing on the configuration of the router 21A shown in FIG. 1, the other routers 21B to 21D shown in FIG. 1 have a similar configuration.

The interface unit 22 of the router 21A is for carrying out frame transmission/reception to/from all the next hop routers 21B to 21D forming opposite communication parties connected to the transit network 10, and is composed of a receiving unit 31, a transmitting unit 32, a reception rate check unit 33 and a transmission rate check unit 34.

Moreover, the local interface unit 24 is for carrying out packet transmission/reception through the port a2 or a3, shown in FIG. 1, with respect to a local unit such as a terminal accommodated under the router 21A to which it pertains, and is composed of a local receiving unit 35 for packet reception and a local transmitting unit 36 for packet transmission.

Still moreover, the relay control unit 23 is for implementing relay control on data between the interface unit 22 and the local interface unit 24, and is composed of a relay processing unit 37, a routing table 38, a rate control information processing unit 39 and a rate control table 40.

Yet moreover, the receiving unit 31 and the transmitting unit 32 in the interface unit 22 are for conducting the interface between the access lines 15A to 15D and the router 21A to which it pertains. That is, the receiving unit 31 is made to receive a frame from the access lines 15A to 15D and transfer it to the latter-stage relay processing unit 37 after the conversion into a packet, while the transmitting unit 32 is made to convert the packet from the relay processing unit 37 into a frame and transmit this frame through the access lines 15A to 15D.

In addition, the transmitting unit 32 functions as a measurement result notifying unit to notify a measurement result on a reception traffic volume, measured, to all the next hop routers in the aforesaid notification step.

Still additionally, the reception rate check unit 33 is for transferring, of reception packets received from the next hop routers 21B to 21D by the receiving unit 31, a data packet to the relay processing unit 37 for the relay processing to a local unit and for transferring a control packet, which will be mentioned later, to the rate control information processing unit 39.

Yet additionally, this reception rate check unit 33 is made to measure and check a reception traffic volume (reception rate) on a reception packet from the aforesaid receiving unit 31 in the aforesaid traffic volume measuring step, and it functions as a reception traffic volume measuring unit.

Concretely, it measures a reception rate of a reception packet from the receiving unit 31 and makes a decision as to whether or not the measurement result exceeds a predetermined threshold. That is, if this reception rate check unit 33 shows that the reception rate of the reception packet exceeds the predetermined threshold, a rate-over flag area of the rate control table 40, which will be mentioned later, is set at “1” and the reception rate control is set into an active state (so-called flag-rising state).

In other words, the reception rate check unit 33 functions as a reception traffic volume measuring unit to measure a reception traffic volume (reception rate) on data received from all the next hop routers 21B to 21D through the transit network 10 and further functions as a threshold decision unit to make a decision as to magnitude relation between the reception traffic volume measured in the reception traffic volume measuring unit and a predetermined threshold.

Furthermore, the transmission rate check unit 34 is made to receive, from there lay control unit 23, transmission packet data to be transmitted through the transit network 10 to the next hop routers 21B to 21D and measure a transmission traffic volume (transmission rate) on this transmission packet data for carrying out transmission rate suppression control or increase control according to an instruction from the rate control information processing unit 39 which will be mentioned later.

Concretely, the transmission rate check unit 34 is made to carry out suppression control for conducting frame transmission at a suppression rate determined for each of the reception side routers 21B to 21D or to implement increase control for increasing transmission rate gradually from a suppression control condition.

Accordingly, in the aforesaid transmission traffic control step, in cooperation with the rate control information processing unit 39 which will be mentioned later, the aforesaid transmission rate check unit 34 functions as a transmission traffic volume control unit to, when receiving a notification on a measurement result of a reception traffic volume in any one of the next hop routers from this next hop router, control a transmission traffic volume to this next hop router in accordance with the measurement result notified from this next hop router.

Still furthermore, the relay processing unit 37 of the relay control unit 23 is made to make a reference to a routing table 38 recording routing information for conducting routing processing on a data packet from the reception rate check unit 33 to transfer it to the transmitting unit 36, with this data packet being transferred through the local transmitting unit 36 to the local unit which is a destination.

Likewise, this relay processing unit 37 makes a reference to the routing table 38 to conduct routing processing on a data packet received through the local receiving unit 35 for transferring it to the interface unit 22, with this data packet from the local receiving unit 35 being transmitted through the transmitting unit 32 to the access line 15A after processed in the transmission rate check unit 34 of the interface unit 22.

Yet furthermore, the rate control information processing unit 39 is for, when the aforesaid reception rate check unit 33 shows that the reception traffic volume exceeds the predetermined threshold, carrying out first control information processing when the information to the effect of it is inserted into a control packet and notified to all the next hop routers 21B to 21D and second control information processing when a control packet is received from the next hop routers 21B to 21D to control a transmission traffic on data to be transmitted to the next hop routers 21B to 21D.

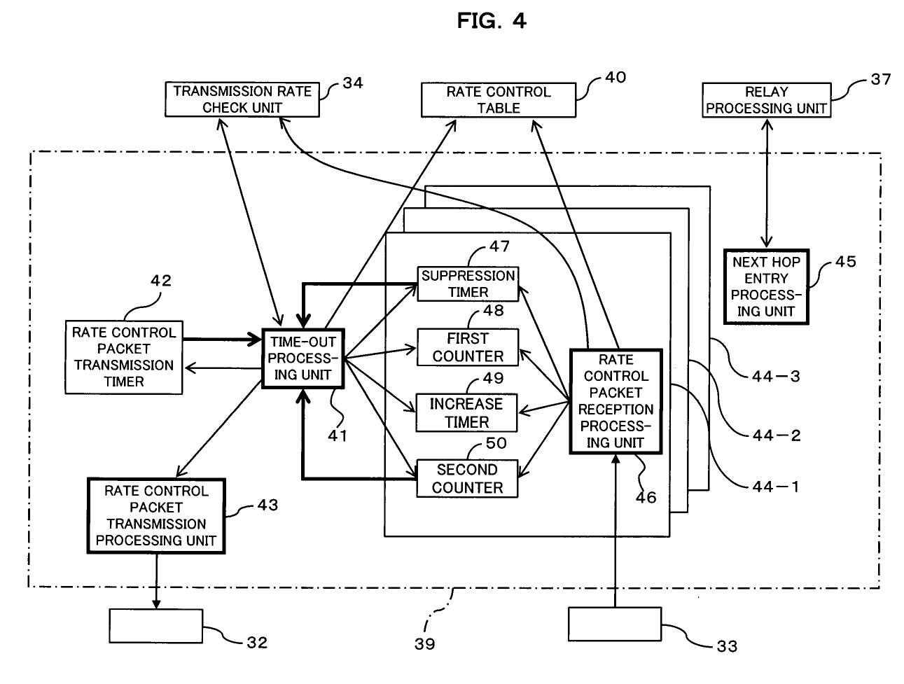

As a functional aspect, as shown in FIG. 4, the rate control information processing unit 39 is composed of a time-out processing unit 41, a rate control packet transmission timer 42, a rate control packet transmission processing unit 43, processing units 44-1 to 44-3 provided to correspond to the next hop routers 21B to 21D, and a next hop entry processing unit 45.

The aforesaid time-out processing unit 41, rate control packet transmission timer 42 and rate control packet transmission processing unit 43 constitute a functional unit for conducting the aforesaid first control information processing, while the aforesaid time-out processing unit 41 and processing units 44-1 to 44-3 organize a functional unit for conducting the aforesaid second control information processing.

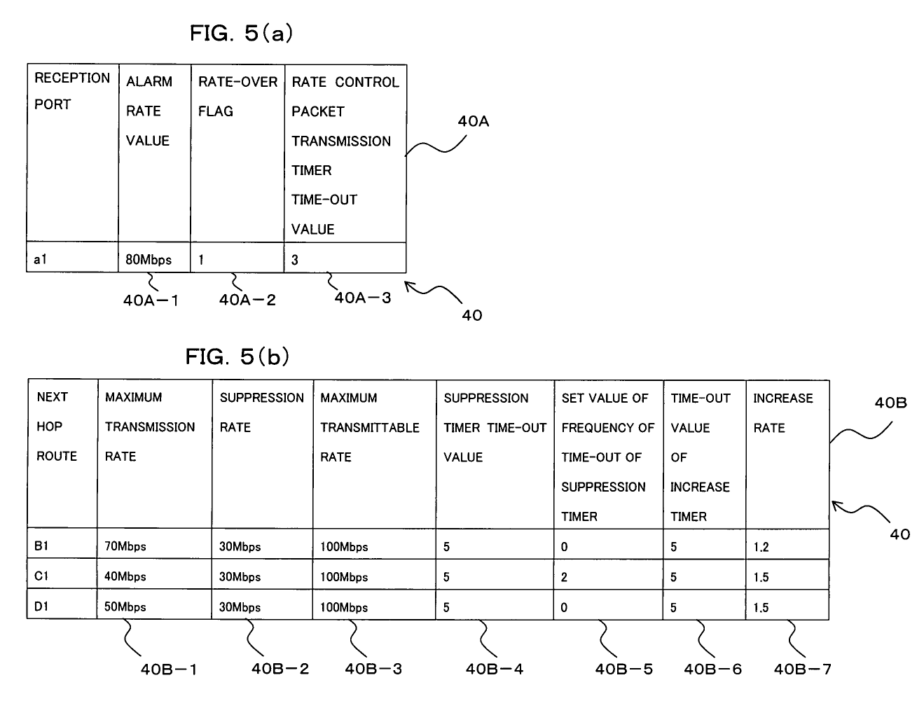

Moreover, the rate control data 40 is for managing control data for control information processing in the aforesaid rate control information processing unit 39, and includes a first table 40A for the aforesaid first control information processing, for example, shown in FIG. 5(a) and a second table 40B for the aforesaid second control information processing, for example, shown in FIG. 5(b).

That is, the first table 40A shown in FIG. 5(a) is composed of an alarm rate storing areas 40A-1, a rate-over flag storing area 40A-2 and a rate control packet transmission timer set value storing area 40A-3.

An alarm rate to be stored in the storing area 40A-1 is a reference value (threshold) to be taken for making a comparison with a reception rate of a reception packet received through a reception port al connected to the access line 15A. That is, in the reception rate check unit 33, the alarm rate (in this case, 80 Mbps) stored in the storing area 40A-1 is used as a threshold and compared in magnitude with a measured reception traffic volume so that, when the reception traffic volume exceeds the alarm rate, “1” is set in the storing area 40A-2.

The time-out processing unit 41 of the rate control information processing unit 39 is triggered by setting “1” in the aforesaid storing area 40A-2 and made to output production and transmission instructions for a rate control packet to the rate control packet transmission processing unit 43 and to activate the rate control packet transmission timer 42 with a value (in this case, timer value “3”) stored in the storing area 40A-3 as a time-out value.

When receiving a rate control packet transmission instruction from the time-out processing unit 41, the rate control packet transmission processing unit 43 produces a rate control packet and outputs it to the transmitting unit 32 of the interface unit 22, and when receiving a time-out notification on the rate control packet transmission timer 42 from the time-out processing unit 41, it stops the production of this rate control packet.

In other words, the rate control packet transmission processing unit 43 produces a rate control packet while the aforesaid rate control packet transmission timer 42 is in operation, and outputs it to the transmitting unit 32 of the interface unit 22. Therefore, the aforesaid rate control packet transmission processing unit 43 functions as a control data producing unit to produce, as a rate control packet, control data corresponding to a measurement result to be notified through the frame transmission by the transmitting unit 32, on the basis of a reception traffic volume measured in the reception rate check unit 33.

In addition, when a result of the threshold decision in the reception rate check unit 33 shows that the reception traffic volume exceeds the predetermined threshold, the rate control packet transmission processing unit 43 serving as a control data producing unit produces a rate control packet as control data including the information to the effect of it.

That is, the rate control packet produced in this rate control packet transmission processing unit 43 can notify to the next hop routers 21B to 21D that its own (router 21A) reception traffic volume exceeds the predetermined threshold and the probability of the occurrence of frame abandonment in the transit network 10 acting as the layer 2 (L2) virtual facility network or in the access line 15A is relatively high.

Still additionally, since the aforesaid control packet can be placed in a frame to be transmitted through the access line 15A, the transmitting unit 32 can transmit the rate control packet through the transit network 10 to each of the next hop routers 21B to 21D. Accordingly, the rate control packet is transmitted as a measurement result of a reception traffic volume through the transmitting unit 32, which enables a request to all the next hop routers 21B to 21D for control on the traffic volume on transmission data to the router 21A, it pertains to.

That is, when the result of the threshold decision in the reception rate check unit 33 indicates that the reception traffic volume exceeds the threshold, the transmitting unit 32 serving as a measurement result notifying unit makes a notification to the next hop routers 21B to 21D as a request for the suppression of transmission data to the router 21A, it pertains to, in order to prevent the congestion which can occur in the transit network 10 or in the access lines 15A to 15D.

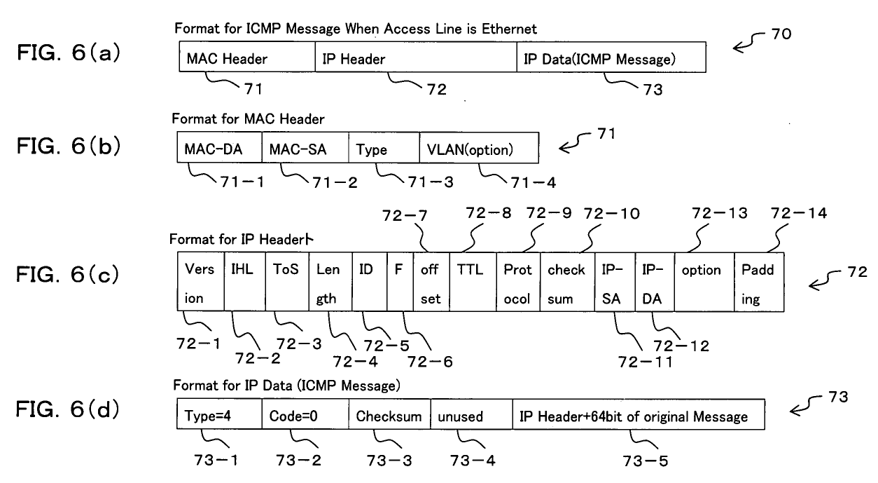

In this case, as the above-mentioned rate control packet, there is employable ICMP Source Quench Message (message to be transmitted for, when a router is short of resource needed for the reception or replay of packets, suppressing the transmission from a transmission side of a frame acting as a trigger). In a case in which the access lines 15A to 15D are Ethernet (R), the aforesaid rate control packet is producible with formats, for example, shown in FIGS. 6(a) to 6(d).

That is, an ICMP message 70 serving as a rate control packet is composed of areas of an MAC header 71, an IP header 72 and IP data 73 as shown in FIG. 6(a). The MAC header 71 includes a reception side physical address (MAC-DA) 71-1, a transmission side physical address (MAC-SA) 71-2, a type 71-3 and optional VLAN information 71-4 as shown in FIG. 6(b).

Moreover, as shown in FIG. 6(c), the format for the IP header 72 includes Version information 72-1, IHL 72-2, toS 72-3, Length 72-4, ID 72-5, F 72-6, Offset 72-7, TTL 72-8, Protocol 72-9, Check sum 72-10, IP Transmission side address (IP-SA) 72-11, IP Reception side address (IP-DA) 72-12, Option 72-13 and Padding 72-14.

Still moreover, as shown in FIG. 6(d), the format for the IP data 73 includes Type information 73-1 of “Type=4”, Code information 73-2 of “Code=0”, Check sum 73-3, unused 73-4 and IP Header+Message (IP Header+64 bit of original Message) 73-5.

In a case in which a rate control packet according to the aforesaid frame format is transmitted to be broadcasted in a subnet, all “1” signifying the broadcasting is set as the aforesaid reception side physical address 71-1, and a value for in-subnet broadcasting is set as the IP transmission side address 72-11, and all “0” depicting the rate control packet is set in the IP header+Message 73-5.

Yet moreover, in a case in which a rate control packet according to the aforesaid frame format is individually transmitted to the respective next hop routers, an MAC address of a next hop router is set as the aforesaid reception side physical address 71-1, and an IP address of a next hop router is set as the IP transmission side address 72-11, and all “0” representing a rate control packet is set in the IP Header+Message 73-5.

Furthermore, for the above-mentioned second control information processing, each of the processing units 44-1 to 44-3 provided in corresponding relation to the aforesaid next hop routers 21B to 21D is functionally made up of a rate control packet reception processing unit 46, a suppression timer 47, a first counter 48 for counting the number of times of time-out of the suppression timer 47, an increase timer 49 and a second counter 50 for counting the number of times of time-out of the increase timer 49.

In this configuration, the rate control packet reception processing unit 46 is made to, when receiving a rate control packet from the next hop routers 21B to 21D through the reception rate check unit 33, give an instruction on transmission rate control to the transmission rate check unit 34 on the basis of the timer values and count values managed in the suppression timer 47, the first counter 48, the increase timer 49 and the second counter 50 in a manner such that the rate control packet is used as a trigger.

Concretely, when receiving the rate control packet from the next hop routers 21B to 21D, the suppression timer 47, the first counter 48 and the time-out processing unit 41 manage a period of time to be taken for suppressing the transmission rate from the router 21A to the next hop routers 21B to 21D, while the increase timer 49, the second counter 50 and the time-out processing unit 41 manages a period of time to be taken for increasing the suppressed transmission rate gradually.

The suppression timer 47 is activated when the rate control packet reception processing unit 46 receives the rate control packet from the next hop routers 21B to 21D and is made to measure the time of the suppression control on the transmission rate being implemented in the transmission rate check unit 34 which will be mentioned later. Moreover, the first counter 48 is for counting the number of times of time-out of the aforesaid suppression timer 47 and, when this frequency of time-out reaches a reference frequency, the aforesaid transmission rate check unit 34 shifts the transmission rate control from the suppression control to the increase control.

Therefore, in cooperation with the rate control information processing unit 39, the transmission rate check unit 34 serving as a transmission traffic control unit carries out the control to set the transmission traffic volume to a next hop router (for example, router 22C) at a first traffic volume, suppressed, (suppression rate) for a first period of time after receipt of a notification on a request for the control of the traffic on transmission data from the next hop router 22C, and carries out the control to increase the transmission traffic volume gradually toward a second traffic volume, intended, (maximum transmission rate) for a second period of time after the elapse of the first period of time.

The increase timer 49 is for measuring the time of the transmission rate increase control being implemented in the transmission rate check unit 34. Moreover, the second counter 50 is for counting the number of times of time-out of the increase timer 49. The time-out processing unit 41 is made to conduct the time-out processing on the aforesaid rate control packet transmission timer and further to conduct the time-out processing on the suppression timer 47, the first counter 48, the increase timer 49 and the second counter 50.

For each of the next hop routers 21B to 21D, the second table 40B [see FIG. 5(b)] for the second control information processing includes a maximum transmission rate storing area 40B-1, a suppression rate storing area 40B-2, a maximum transmittable rate storing area 40B-3, a storing area 4DB-4 for storing a reference value of frequency of time-out of the suppression timer 47, an area 4DB-5 for storing a reference value of frequency of time-out of the suppression timer 47, a storing area 4DB-6 for storing a state of the increase timer 49, and a storing area 40B-7 for storing an increase rate.

The maximum transmission rate storing area 40B-1 is for storing a maximum transmission rate at normal timer which is to be set for each of the next hop routers 21B to 21D. In this case, the maximum transmission rate to the router 21B is set at 70 Mbps, the maximum transmission rate to the router 21C at 40 Mbps and the maximum transmission rate to the router 21D at 50 Mbps.

Moreover, the suppression rate storing area 40B is for storing a suppression rate (maximum transmission rate at suppression control) to be set for each of the next hop routers 21B to 21D. In this case, each of the suppression rates to the routers 21B to 21D is set at 30 Mbps.

Still moreover, the maximum transmittable rate storing area 40B-3 is for storing a maximum transmittable rate to each of the routers 21B to 21D which is to be determined on the basis of the assurance bands of the access lines 15A to 15D and the transit network 10. In this case, each of the suppression rates to the routers 21B to 21D is set at 100 Mbps.

Yet moreover, the storing area 40B-4 is an area in which a time-out value of the suppression timer 47 is stored for each of the routers 21B to 21D, while the storing area 40B-5 is an area in which a reference value of frequency of time-out of the suppression timer 47 is stored for each of the routers 21B to 21D. That is, the timer-out processing unit 41 is made to activate the suppression timer 47 at a time-out value set for each of the routers 21B to 21D by making a reference to the contents of this table 40B and further to count the number of times of time-out for shifting to the increase control through the use of the first counter 48.

In addition, the storing area 40B-6 is an area in which a time-out value of the increase timer 49 is stored for each of the routers 21B to 21D, while the storing area 40B-7 is an area in which a reference value of frequency of time-out of the increase timer 48 is stored for each of the routers 21B to 21D. That is, the time-out processing unit 41 is made to activate the increase timer 48 at a time-out value set for each of the routers 21B to 21D, which implements the increase control, by making a reference to the contents of this table 40B and further to count the number of times of time-out in the increase timer 49 through the use of the second counter 50.

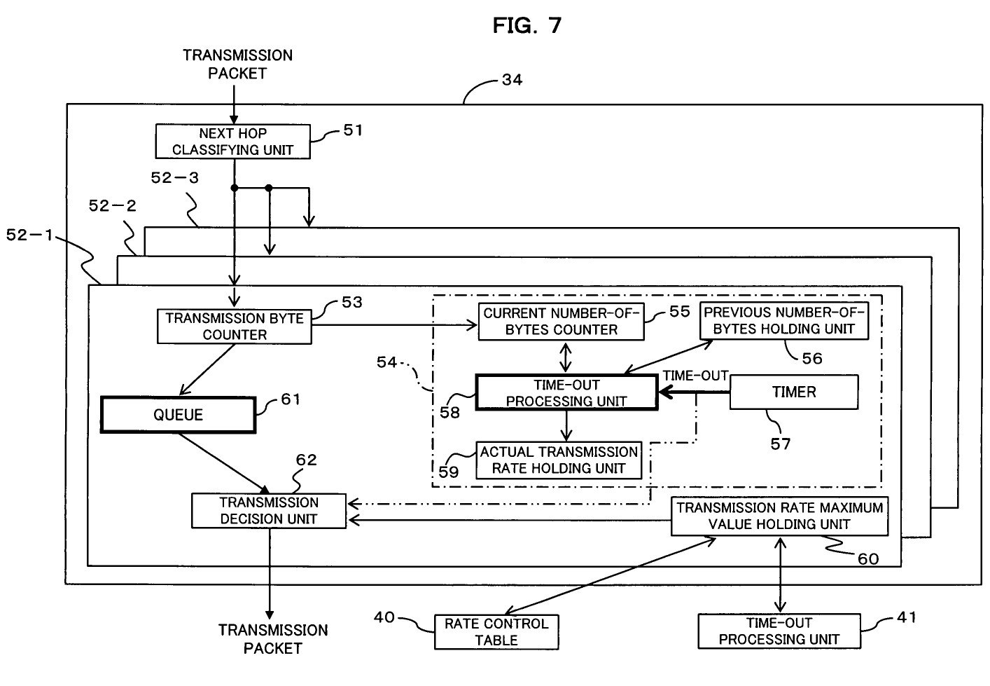

Still additionally, as shown in detail in FIG. 7, the transmission rate check unit 34 of the interface unit 22 is composed of a next hop classifying unit 51 and transmission rate control units 52-1 to 52-3 provided for the respective next hop routers.

For example, in the router 20A, the transmission rate control unit 52-1 is made to control the transmission rate of a data packet to the next hop router 20B, and the transmission rate control unit 52-2 is made to control the transmission rate of a data packet to the next hop router 20C, and the transmission rate control unit 52-3 is made to control the transmission rate of a data packet to the next hop router 20D.

The next hop classifying unit 51 is made to classify data packets, transferred from the relay processing unit 37, for each next hop router forming a reception side router, with the data packets classified for each next hop router being transferred to the transmission rate control units 52-1 to 52-3 of each corresponding next hop router.

Still additionally, each of the transmission rate control units 52-1 to 52-3 is made to control the transmission rate on the aforesaid data packet classified for each router and hand it over to the transmitting unit 32 and is composed of a transmission byte counter 53, an actual transmission rate calculating unit 54, a transmission rate maximum value holding unit 60, a queue 61 and a transmission decision unit 62.

For example, in the transmission rate control unit 52-1 of the router 20A, the transmission byte counter 53 is made to count the number of transmission bytes of a data packet addressed to the router 20B. The actual transmission rate calculating unit 54 is made to calculate an actual transmission rate on the basis of the transmission bytes counted by the transmission byte counter 53 and is composed of a current number-of-byte holding unit 55, a previous number-of-byte holding unit 56, a timer 57, a time-out processing unit 58 and an actual transmission rate holding unit 59.

The current number-of-byte holding unit 55 is made to add up the numbers of transmission bytes counted in the transmission byte counter 53 and hold it, and the previous number-of-byte holding unit 56 is made to store the number of transmission bytes held in the current number-of-byte holding unit 55 immediately before a time-out time managed in the timer 57.

Moreover, the time-out processing unit 58 is for conducting the time-out processing every predetermined time managed in the timer 57. Concretely, it calculates an actual transmission rate through the use of values held in the current number-of-byte holding unit 55 and the previous number-of-byte holding unit 56 every predetermined time managed in the timer 57 and writes a value, held in the current number-of-byte holding unit 55, in the previous number-of-byte processing unit 56.

Concretely, in the time-out processing unit 58, as expressed by an equation (1), the number of transmission bytes per unit time is calculated as an actual transmission rate, and the calculation result is held in the actual transmission rate holding unit 59.

In other words, the time-out processing unit 58 obtains the number of transmission bytes, counted for a predetermined time managed by the timer 57, on the basis of the difference between the number of transmission bytes held in the current number-of-byte counter 55 and the number of bytes held in the previous number-of-byte holding unit 56 and divides the obtained number of transmission bytes by a time-out interval in the timer 57, thereby calculating an actual transmission rate.
Actual Transmission Rate={(Current Number of Bytes) −(Previous Number of Bytes)}/(Time-out Interval) (1)

Still Moreover, the transmission rate maximum value holding unit 60 is made to hold the maximum value of the transmission rate set in the aforesaid time-out processing unit 41. The queue 61 is made to queue the data packets counted in number of transmission bytes in the transmission byte counter 53 in accordance with priority such as a predetermined WFQ (Waited Fair Queuing) or the like.

In other words, in carrying out the transmission traffic control, owing to the aforesaid queue 61, the transmission traffic volume is controllable while transmitting the transmission data according to the priority.

Yet moreover, the transmission decision unit 62 is made to control the transmission rate on the basis of the actual transmission rate calculated in the actual transmission rate calculating unit 54 and the transmission rate maximum value held in the transmission rate maximum value holding unit 60. Concretely, the transmission decision unit 62 is designed to carry out the limiter control by making a decision on the right of transmission so that the aforesaid actual transmission rate does not exceed the maximum transmission rate when a data packet is derived from the queue 61 and transferred as a transmission packet to the transmitting unit 32.

In the aforesaid transmission decision unit 62, the time-out from the timer 57 or the queuing of a transmission packet from the transmission byte counter 53 is used as a trigger for making the aforesaid transmission decision.

The function as the reception traffic measuring unit depending on the aforesaid reception rate check unit 33, the measurement result notifying unit depending on the cooperation among the transmitting unit 32, the rate control information processing unit 39 and the rate control table 40, and the function as the transmission traffic control unit depending on the cooperation among the transmission rate check unit 34, the rate control information processing unit 39 and the rate control table 40 are realizable in a manner such that a processor carries out a program developed on a memory which is not shown. Moreover, it is also realizable in a manner such that this program is read out from a recording medium such as DVD or CD-ROM, which stores the program, and a processor carries out the program developed on a memory.

(a3) Description of Traffic Control Operation in the Routers 20A to 20D Connected to the Transit Network 10 According to First Embodiment of the Present Invention Focusing on the control in the router 20A, a description will be given hereinbelow of, in the above-described configuration, a flow of traffic control in the routers 20A to 20D connected to the transit network 10 according to the embodiment of the present invention.

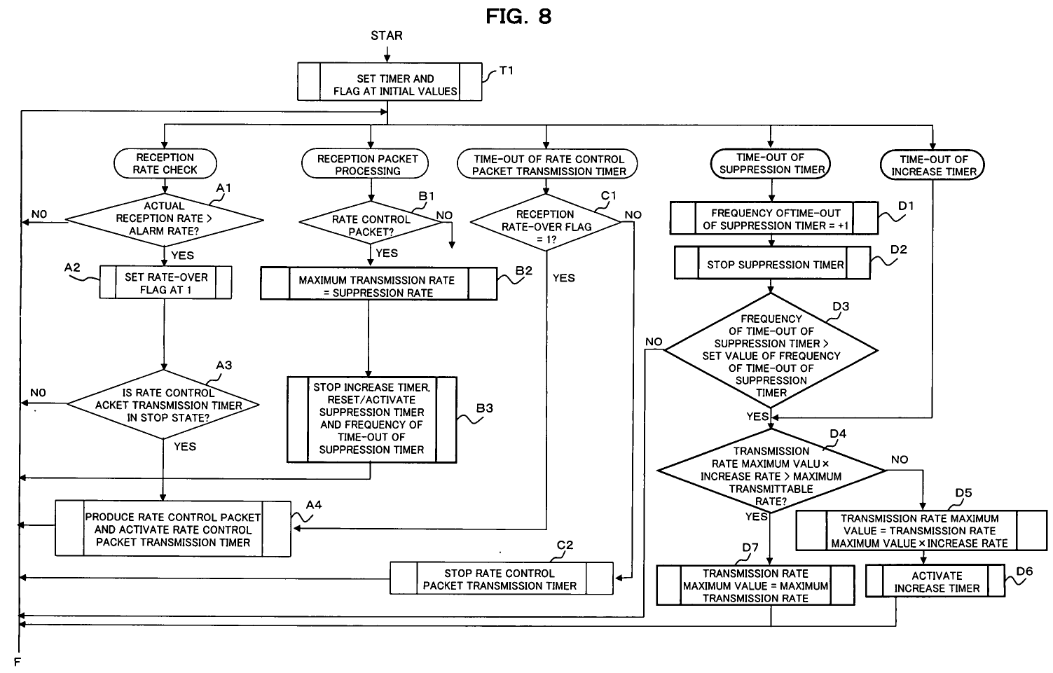

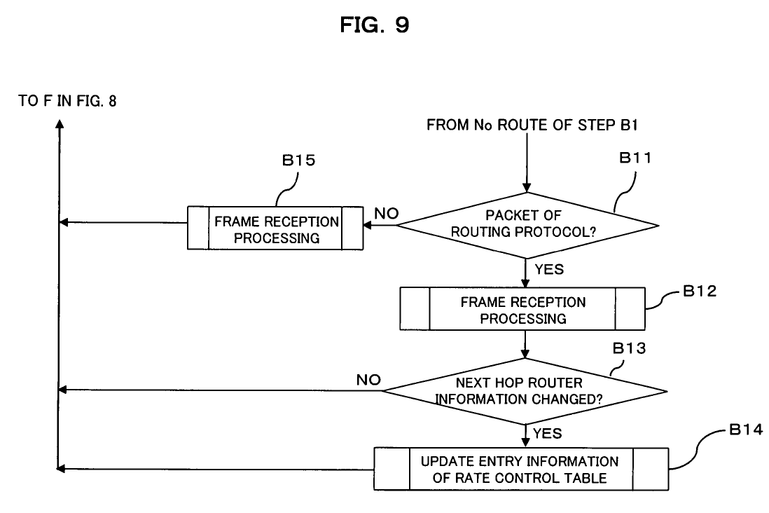

First, with reference to flow charts of FIGS. 8 and 9, a description will be given hereinbelow of the processing to be conducted in the router 20A when a frame is received from the next hop routers 20B to 20D.

In the router 20A, in a case in which a program is executed in order to fulfill the functions as the aforesaid reception rate check unit 33, the transmission rate check unit 34, the rate control information processing unit 39 of the relay control unit 23 and the rate control table 40, the following five types of interruption processing will be conducted from a state in which the set values of timers, flags and others are set to initial set values (step T1).

First, when the receiving unit 31 of the interface unit 22 receives a frame, this receiving unit 31 converts it into a packet signal and, subsequently, the reception rate check unit 33, the rate control information processing unit 39 and the rate control table 40 cooperate with each other to conduct reception rate check processing (reception traffic measurement step, steps A1 to A4 shown in FIG. 8) and reception packet processing (steps B1 to B3 shown in FIG. 8, B11 to B15 shown in FIG. 9).

That is, the reception rate check unit 33 calculates a reception rate on a packet signal from the receiving unit 31 and makes a comparison in magnitude between the calculation result and an alarm rate value read out from the first table 40A of the rate control table 40. Incidentally, as mentioned above, the alarm rate value is set in the storing area 40A-1 [see FIG. 5(a)] of the first table 40A in corresponding relation to the port a1 (see FIG. 1) of the router 20A.

In a case in which a result of the comparison between the calculated reception rate and the alarm rate shows that the reception rate exceeds the alarm rate, in the storing area 40A-2 of the first table 40A, “1” is set as a rate-over flag (step A2 through YES route of step A1).

When the rate-over flag “1” is set in the aforesaid storing area 40A-2, if the rate control packet transmission timer 42 is not in an activated condition, the time-out processing unit 41 of the rate control in formation processing unit 39 activates this rate control packet transmission timer 42, and gives an instruction for the production of a rate control packet to the rate control packet transmission processing unit 43.

Thus, upon receipt of the instruction from the time-out processing unit 41, the rate control packet transmission processing unit 43 produces a rate control packet, and the transmitting unit 32 inserts it into a data packet forming a transmission packet framed. In other words, the rate control packet is transmitted, as a frame to be transmitted from the transmitting unit 32, to the next hop routers 20B to 20D (step A4 through YES route of step A3).

That is, through the use of this rate control packet, with respect to frame data received by the router 21A it pertains to, a notification to the effect that a possibility of the occurrence of frame abandonment due to congestion in the access line 15A or the transit network 10 is made to the next hop routers 21B to 21D.

In a case in which the result of the reception rate comparison in the reception rate check unit 33 in the aforesaid step A1 shows that the reception rate does not exceed the alarm rate, the rate-over flag in the storing area 40A-2 is set at “0”, and the interruption processing serving as the reception rate check processing comes to an end (NO route of step A1). Moreover, if the rate control packet transmission timer 42 is already in activation in the step A3, since the rate control packet is already transmitted, the interruption processing serving as the reception rate check processing comes to an end (NO route of step A3).

In addition, as the second interruption processing, on the reception packets which undergo the aforesaid reception rate check, the reception packet processing is conducted according to packet types (steps B1 to B3) That is, when, in the reception rate check unit 33, an identification is made as the reception packet is a rate control packet [see FIGS. 6(a) to 6(d)] from the next hop routers 20B to 20D, this rate control packet is handed over to the rate control packet reception processing unit 46 (see FIG. 4) of the rate control information processing unit 39, and the following rate control is implemented on a transmission packet to the rate control packet transmission side router (transmission traffic control step).

That is, upon receipt of a rate control packet, the rate control packet reception processing unit 46 sets the maximum transmission rate for the aforesaid rate control packet transmission side router (for example, router 20C) at a suppression rate by making a reference to the rate control table 40.

Concretely, the rate control packet reception processing unit 46 rewrites the transmission rate maximum value, which is held in the transmission rate maximum value holding unit 60 of the transmission rate control unit 52-2 corresponding to the router 20C in the transmission rate check unit 34, into a suppression rate (corresponding to the router 20C) read out from the storing area 40B-2 [see FIG. 5(b)] of the second table 40B (step B2 through YES route of step B1). In this case, the transmission rate maximum value is rewritten from the maximum transmission rate of 40 Mbps into a suppression rate of 30 Mbps.

This prevents the congestion which can occur in the access line 15C or the transit network 10, thus preventing the occurrence of frame abandonment of a reception frame to be received by the router 21C.

In addition, when the increase timer 49 is in activation, the rate control packet reception processing unit 46 stops the increase timer 49 and resets and activates the suppression timer 47 (the timer value is set at “0”) and further resets the count value (the number of times of time-out of the suppression timer 47) of the first counter 49 (the count value is set at “0”, step B3).

In a case in which, when the aforesaid reception packet processing interruption takes place, a decision is made that the reception packet is not a rate control packet, if the aforesaid reception packet is a packet according to a routing protocol, for example, the reception rate check unit 33 conducts frame reception processing according to this routing protocol (NO route of step B1, step B12 through YES route of step B11 shown in FIG. 9).

At this time, if information change does not arise in the next hop routers 20B to 20D, the interruption for the reception packet processing comes to an end (NO route of step B13), and if the information change arises in the next hop routers 20B to 20D, the reception rate check unit 33 updates the entry information in the second table 40B constituting the rate control table 40.

That is, the reception rate check unit 33, when receiving a packet according to the routing protocol, takes out the updated contents of the entry information of the next hop routers 20B to 20D from this packet and updates the set values stored in the storing areas 40B-1 to 40B-7, which are objects of updating on the second table 40B, and the interruption for the reception packet processing comes to an end (step B14 through YES route of step B13).

If the aforesaid reception packet is not a packet according to the routing protocol but is a normal data packet, the normal frame reception processing is conducted to transfer this data packet to the relay processing unit 37 (NO route of step B1, step B15 through NO route of step B11).

In other words, the contents of the rate control table 40 of the router 20A can be updated from the next hop routers 20B to 20D through the packet according to the aforesaid routing protocol.

Following this, in the rate control information processing unit 39, when the value of the rate control packet transmission timer 42 reaches a value (in this case, “3”) stored in the storing area 40A-3 of the rate control table 40, which signifies the occurrence of time-out, interruption processing are conducted in steps C1, C2 and A4.

That is, when the time-out occurs in the rate control packet transmission timer 42, the time-out processing unit 41 makes a reference to a state of the rate-over flag in the storing area 40A-2 of the rate control table 40.

At this time, if the rate-over flag shows “0”, the time-out processing unit 41 stops the rate control packet transmission timer 42 and the interruption processing comes to an end (step C2 through NO route of step C1). On the other hand, if the rate-over flag shows “1”, the time-out processing unit 41 again gives an instruction to the rate control packet transmission processing unit 43 for the production of a rate control packet and the transmission control, and activates the rate packet transmission timer 42 (step A4 through YES route of step C1), and the interruption processing comes to an end.

Subsequently, in the rate control information processing unit 39, when the value of the suppression timer 47 activated reaches a value (in this case, “5”) stored in the storing area 40B-4 of the rate control table 40, which signifies the occurrence of time-out, the interruption processing are conducted in steps D1 to D7.

That is, when the time-out of the suppression timer 47 occurs, the time-out processing unit 41 increments the value of the first counter 48, indicating the frequency of time-out of the suppression timer 47, by “1” (step D1) and stops the suppression timer 47 (step D2).

Furthermore, in a case in which the value stored in the storing area 40B-5 of the rate control table 40 exceeds the value of the first counter 48, i.e., if the number of times of time-out of the suppression timer 47 exceeds a set value of frequency of time-out of the suppression timer 47, the transmission rate maximum value held in the transmission rate maximum value holding unit 60 (see FIG. 7) of the transmission rate check unit 34 is set to be gradually increased from the suppression rate toward the maximum transmission rate stored in the storing area 40B-1 of the rate control table 40 (YES route of step D3).

Concretely, the time-out processing unit 41 makes a decision as to whether or not a value obtained by multiplying the transmission rate maximum value held in the maximum transmission rate holding unit 60 by a value stored in the storing area 40B-7 of the rate control table 40 exceeds the maximum transmission rate stored in the storing area 4DB-1, and if it does not exceed the stored value, updates the maximum transmission rate holding unit 60 so that the value obtained by the aforesaid multiplication is set as a new transmission rate maximum value (step D5 through NO route of step D4), and activates the increase timer 49 (step D6), and the interruption processing comes to an end.

If a decision is made such that the value obtained by the aforesaid multiplication exceeds the maximum transmission rate stored in the storing area 40B-1, the time-out processing unit 41 updates the maximum transmission rate holding unit 60 so that this maximum transmission rate is set as a new transmission rate maximum value (step D7 through YES route of step D4), and the interruption processing comes to an end.

If the decision in the aforesaid step D3 shows that the number of times of time-out of the suppression timer 47 does not exceed the set value of frequency of time-out of the suppression timer 47, the interruption processing terminates at this time.

Moreover, in the rate control information processing unit 39, when the value of the increase timer 49 activated reaches a value (in this case, “5”) stored in the storing area 40B-6 of the rate control table 40, because of the occurrence of time-out, as well as the above-mentioned case, the time-out processing unit 41 increases and sets the transmission rate maximum value gradually toward the maximum transmission rate (steps D4 to D7).

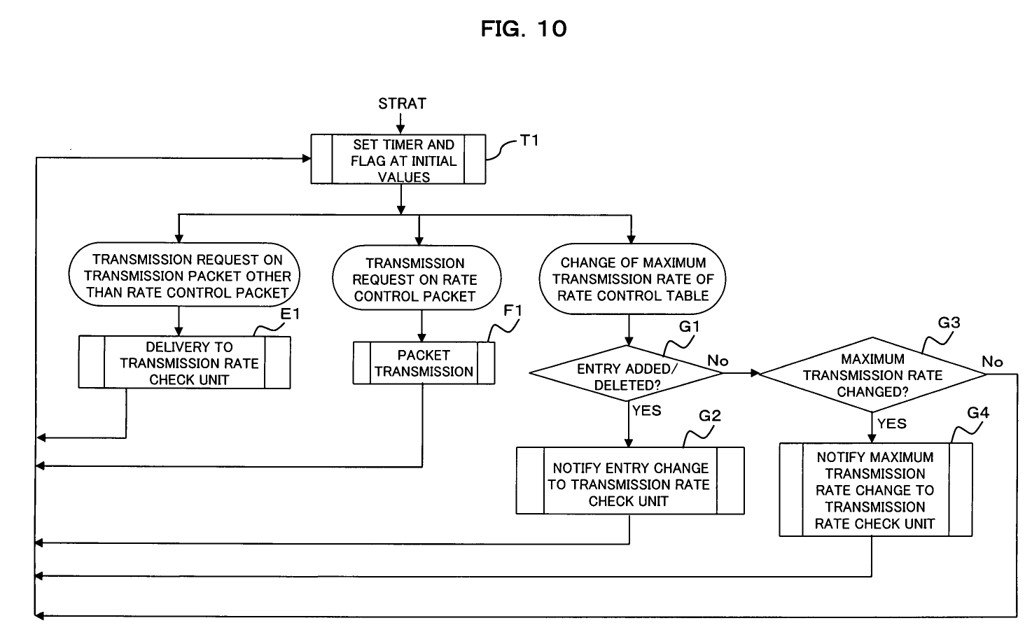

Furthermore, referring to a flow chart of FIG. 10, a description will be given hereinbelow of the processing to be conducted when the router 20A transmits a frame to the next hop routers 20B to 20D. The transmission rate check in the transmission rate check unit 34 is conducted in unit of next hop router.

That is, in the router 20A, for the transmission of a frame to the next hop routers 20B to 20D, when a program is executed in order to fulfill the functions as the aforesaid reception rate check unit 33, transmission rate check unit 34, rate control information processing unit 39 of the relay control unit 23 and rate control table 40, the following three types of interruption processing are conducted by means of interruption from a state in which set values of timers, flags and others are set at initial set values.

That is, in the rate control packet transmission processing unit 43 of the rate control information processing unit 39, when receiving an instruction on the production of a rate control packet and transmission processing from the time-out processing unit 41, the rate control packet transmission processing unit 43 outputs a rate control packet to the transmitting unit 32 as the interruption processing. The transmitting unit 32 processes the rate control packet together with other transmission packets into the form of a frame and transmits it to the next hop routers 20B to 20D (notification step, step F1).

In addition, transmission packets other than the aforesaid rate control packet are framed in the transmitting unit 32 through the processing in the transmission rate check unit 34. For example, in the transmission decision unit 62, a transmission data packet undergoing the routing processing in the relay processing unit 37 is derived from the queue 61 under the rate control of preventing it from exceeding a transmission rate set in the transmission rate maximum value holding unit 60 for each of the reception side next hop routers 20B to 20D, and is outputted to the transmitting unit 32 (step E1).

At this time, if the entry information in the rate control table 40 is updated (see step B14 in FIG. 9), a notification on this fact is made to the transmission rate check unit 34 (steps G1 to G4).

That is, in a case in which an entry is added or deleted in the contents of the rate control table 40, for example, in the case of addition or deletion of the next hop routers 20B to 20D forming other communication parties registered in the rate control table 40, this entry change is notified to the transmission rate check unit 34 (step G2 through YES route of step G1).

Moreover, in a case in which the updating contents of the rate controltable 40 do not relate to addition or deletion of the next hop routers 20B to 20D forming other communication parties and in the case of a change of the maximum transmission rate stored in the storing area 40B-1 of the rate control table 40, this change of the maximum transmission rate is notified to the transmission rate check unit 34 (NO route of step G1, step G4 through YES route of step G3).

As described above, according to an embodiment of the present invention, since the router is equipped with the reception rate check unit 33, the transmission rate check unit 34, the rate control information processing unit 39 and the rate control table 40, the routers 21A to 21D themselves connected to edges of users measure their own reception quantity and, when congestion tends to occur in the access lines 15A to 15D or in the transit network 10, notify this fact to the other routers 21A to 21D so that the router, receiving the notification, adjusts the transmission quantity to prevent the occurrence of frame abandonment. As advantages, this enables constructing a network in which the communication efficiency does not degrade in the case of the employment of a layer 2 virtual private network which does not have a frame abandonment notification function and an abandonment function based on priority.

In particular, even if the probability of the occurrence of frame abandonment becomes relatively high due to the association with a queuing function such as WFQ in the router, the employment of the layer 2 virtual private network becomes easy for communications handling data in a manner such that a traffic volume of data with a relatively low priority is decreased while a traffic volume on data to be set at a high priority, such as data on real-time-system applications including voice or stream and data on important service, is secured on a preferential basis.

In addition, when providing, to users, a router supporting the functions according to the present invention as a router for the connection to a layer 2 virtual private network, a network carrier can also provide an integrated network service employing a layer 2 virtual private network and oriented to enterprises.

Although in the above-described embodiment each of the routers 21A to 21D has the functions as the reception traffic volume measuring unit, the measurement result notifying unit and the transmission traffic volume control unit, the present invention is not limited to this. For example, if it is equipped with only the reception traffic volume measuring unit and the measurement result notifying unit, at least the suppression of the traffic volume from the other router to this router is feasible, thus suppressing the congestion or frame abandonment which can occur in the access lines of this router.

Moreover, although in the above-described embodiment a rate control packet is notified as a measurement result on a reception traffic volume according to ICMP, the present invention is not limited to this. For example, when a management server according to a protocol such as SNMP (Simple Network Management Protocol) is provided as a management server for managing a virtual private network, the aforesaid reception traffic volume measurement result can be notified by way of this management server. Alternatively, it is also acceptable that the aforesaid reception traffic volume measurement result is notified according to an original protocol other than the aforesaid ICMP or SNMP.

The present invention is not limited to the above-described embodiment, and covers all changes and modifications which do not constitute departures from the spirit and scope of the invention.

The disclosure of each embodiment of the present invention enables manufacturing by a person skilled in the art.

As described above, a router according to the present invention is useful for constructing a network in which communication efficiency does not degrade in the case of the employment of a virtual private network which does not have a frame abandonment notification function and an abandonment function based on priority and, in particular, it is suitable in the case of the employment of a layer 2 virtual facility network.

1. A router connected through a bridge unit to a transit network constituting a virtual private network, comprising:
a reception traffic volume measuring unit for measuring a reception traffic volume on data received from all next hop routers forming other communication parties, connected through said transit network; and
a measurement result notifying unit for notifying a measurement result on the measured reception traffic volume to all said next hop routers.

2. A router connected through a bridge unit to a transit network constituting a virtual private network, comprising:
a reception traffic volume measuring unit for measuring a reception traffic volume on data received from all next hop routers forming other communication parties, connected to said transit network;
a measurement result notifying unit for notifying a measurement result on the measured reception traffic volume to all said next hop routers;
a transmission traffic control unit for, when receiving a notification on a measurement result of a reception traffic volume in one of said next hop routers from said one next hop router, controlling a traffic volume on data to be transmitted to said one next hop router in accordance with said measurement result notified from said one next hop router.

3. A router connected through a bridge unit to a transit network constituting a virtual private network, comprising:
an interface unit for carrying out transmission/reception of data with respect to all next hop routers forming other communication parties, connected to said transit network; and
a relay control unit for carrying out relay control on data between said interface unit and a local interface unit made to conduct transmission/reception of data with respect to a local unit accommodated thereunder,
said interface unit including:
a reception traffic volume measuring unit for measuring a reception traffic volume on data received from all said next hop routers through said transit network; and
a measurement result notifying unit for notifying a measurement result of said reception traffic volume, measured in said reception traffic volume measuring unit, to all said next hop routers, and
said relay control unit including a control data producing unit for producing control data corresponding to said measurement result to be notified by said measurement result notifying unit on the basis of said reception traffic volume measured in said reception traffic result measuring unit,
the notification on said measurement result by said measurement result notifying unit making a request to all said next hop routers so as to control a traffic volume on data to be transmitted to said own router, respectively.

4. A router connected through a bridge unit to a transit network constituting a virtual private network, comprising:
an interface unit for carrying out transmission/reception of data with respect to all next hop routers forming other communication parties, connected to said transit network; and
a relay control unit for carrying out relay control on data between said interface unit and a local interface unit made to conduct transmission/reception of data with respect to a local unit accommodated thereunder,
said interface unit including:
a reception traffic volume measuring unit for measuring a reception traffic volume on data received from all said next hop routers through said transit network; and
a measurement result notifying unit for notifying a measurement result of said reception traffic volume, measured in said reception traffic volume measuring unit, to all said next hop routers, and
said relay control unit including a control data producing unit for producing control data corresponding to said measurement result to be notified by said measurement result notifying unit on the basis of said reception traffic volume measured in said reception traffic result measuring unit,
the notification on said measurement result by said measurement result notifying unit making a request to all said next hop routers so as to control a traffic volume on data to be transmitted to said own router, respectively, and
said interface unit including a transmission traffic control unit for, when receiving a notification on a measurement result of a reception traffic volume in one of said next hop routers from said one next hop router, controlling a transmission traffic volume on data to be transmitted to said one next hop router in accordance with said measurement result notified from said one next hop router.

5. The router according to claim 3, wherein said interface unit includes a threshold decision unit for making a decision on magnitude relation between said reception traffic volume measured by said reception traffic volume measuring unit and a predetermined threshold, and when a result of the decision in said threshold decision unit shows that said reception traffic volume exceeds said predetermined threshold, said control data producing unit puts this fact into said control data.

6. The router according to claim 4, wherein said interface unit includes a threshold decision unit for making a decision on magnitude relation between said reception traffic volume measured by said reception traffic volume measuring unit and a predetermined threshold, and when a result of the decision in said threshold decision unit shows that said reception traffic volume exceeds said predetermined threshold, said control data producing unit puts this fact into said control data.

7. The router according to claim 5, wherein, when the result of the decision in said threshold decision unit shows that said reception traffic volume exceeds said predetermined threshold, the notification by said measurement result notifying unit makes a request to said next hop router for suppression of a traffic volume on data to be transmitted to said own router, to which it pertains, so as to eliminate a possibility of occurrence of congestion in said virtual private network.

8. The router according to claim 6, wherein, when the result of the decision in said threshold decision unit shows that said reception traffic volume exceeds said predetermined threshold, the notification by said measurement result notifying unit makes a request to said next hop router for suppression of a traffic volume on data to be transmitted to said own router, to which it pertains, so as to eliminate a possibility of occurrence of congestion in said virtual private network.

9. The router according to claim 2, wherein said transmission traffic control unit controls said transmission traffic volume to said next hop router to a first suppressed traffic volume for a first period of time after the notification reception from said one next hop router and, for a second period of time after the elapse of said first period of time, carries out increase control to increase said traffic volume on data to be transmitted gradually toward a second traffic volume intended.

10. The router according to claim 4, wherein said transmission traffic control unit controls said transmission traffic volume to said next hop router to a first suppressed traffic volume for a first period of time after the notification reception from said one next hop router and, for a second period of time after the elapse of said first period of time, carries out increase control to increase said traffic volume on data to be transmitted gradually toward a second traffic volume intended.

11. The router according to claim 2, wherein, when carrying out the transmission traffic control, said transmission traffic control unit controls said transmission traffic volume while transmitting data according to priority.

12. The router according to claim 4, wherein, when carrying out the transmission traffic control, said transmission traffic control unit controls said transmission traffic volume while transmitting data according to priority.

13. The router according to claim 1, wherein said measurement result notifying unit notifies said measurement result according to ICMP (Internet Control Message Protocol).

14. The router according to claim 1, wherein said measurement result in said measurement result notifying unit is notified through a management server made to manage said virtual private network.

15. The router according to claim 1, wherein said measurement result in said measurement result notifying unit is notified according to a format based on an original protocol.

16. A traffic volume control method for a router connected through a bridge unit to a virtual private network, comprising the steps of:
measuring a reception traffic volume on data received from next hop routers through said virtual private network when communication is made with respect to all said next hop routers forming other communication parties connected through said virtual private network;
notifying a measurement result on the measured reception traffic volume to all said next hop routers; and
controlling, in all said next hop routers, a transmission traffic to said router in accordance with the notified measurement result.

17. A communication system comprising a virtual private network and routers, connected through a bridge unit to said virtual private network, for making communication therebetween, wherein a router, which receives data from all next hop routers forming other communication parties connected through said virtual private network, comprises:
a reception traffic volume measuring unit for measuring a reception traffic volume on data received from all said next hop routers; and
a measurement result notifying unit for notifying a measurement result on the measured reception traffic volume to all said next hop routers, and said next hop router, which receives the notification from said measurement result notifying unit, comprises a transmission traffic control unit for controlling a transmission traffic to said router in accordance with the notified measurement result.

18. A traffic control program recorded computer-readable recording medium which is for recording a traffic control program which makes a computer, serving as a router connected through a bridge unit to a virtual private network, carry out a traffic control function to control a traffic volume in said router, said traffic control program making said computer fulfill functions as:
a reception traffic volume measuring unit for measuring a reception traffic volume on data received from all next hop routers, forming other communication parties connected through said virtual private network, through said virtual private network; and
a measurement result notifying unit for notifying a measurement result on the measured reception traffic volume to all said next hop routers.

19. A traffic control program recorded computer-readable recording medium which is for recording a traffic control program which makes a computer, serving as a router connected through a bridge unit to a virtual private network, carry out a traffic control function to control a traffic volume in said router, said traffic control program making said computer fulfill functions as:
a reception traffic volume measuring unit for measuring a reception traffic volume on data received from all next hop routers, forming other communication parties connected through said virtual private network, through said virtual private network;
a measurement result notifying unit for notifying a measurement result on the measured reception traffic volume to all said next hop routers; and
a transmission traffic control unit for, when receiving a notification on a measurement result of a reception traffic volume in any one of said next hop routers from said next hop router, controlling a transmission traffic to said next hop router in accordance with said measurement result notified from said next hop router.
